(19) United States
(12) Patent Application Publication
(10) Pub. No.: US 2025/0190258 A1
(43) Pub. Date: Jun. 12, 2025

(54) SELF-MANAGING SCHEDULER FOR WORKLOADS IN AN INFORMATION PROCESSING SYSTEM

(71) Applicant: Dell Products L.P., Round Rock, TX (US)

(72) Inventors: Ravuru Vijaya Sankar, Bangalore (IN); Rohit Gosain, Bangalore (IN); Shibi Panikkar, Bangalore (IN)

(21) Appl. No.: 18/532,637

(22) Filed: Dec. 7, 2023

(51) Int. Cl. G06F 9/50

(52) U.S. Cl. CPC G06F 9/5027

(57) ABSTRACT

Techniques are disclosed for scheduling workloads in an information processing system. For example, a method comprises maintaining, in a set of nodes managed by a manager node, a scheduler in at least one node, wherein the scheduler is configured to self-manage execution of at least one workload by at least one execution unit instantiated on the node. While not limited thereto, the disclosed techniques are well suited for scheduling microservices in pod-based computing environments.

### FIELD

The field relates generally to information processing systems, and more particularly to scheduling workloads, such as microservices, in such information processing systems.

### BACKGROUND

Microservices are the predominant approach in the modern development of software (e.g., application programs or, more simply, applications, as referred to herein) across a wide variety of computing platforms such as, but not limited to, a cloud computing platform, a private computing platform, a hybrid (cloud/private) computing platform, an edge computing platform, etc. A microservice architecture manages an application as a collection of services. As such, development of an application can be accomplished in a flexible and scalable manner.

Initially, microservices were used in application programming interface (API) environments where synchronous/asynchronous request calls occur (e.g., web applications). However, microservices are now used in container environments, such as container environments based on a Kubernetes container orchestration platform, as well as for batch processing in data pipeline and other data processing architectures.

Microservices are extensively utilized in numerous scheduled jobs. However, their execution is centrally managed by a dedicated scheduler, such as Control-M developed by BMC Software Inc. or Cron Job developed by AT&T Bell Laboratories, which handles the timing of service invocations. Further, with such existing centralized schedulers, a microservice typically remains running at all times, such that when triggered by the scheduler, the microservice executes its designated task.

### SUMMARY

Illustrative embodiments provide improved techniques for scheduling workloads in an information processing system. While not limited thereto, illustrative embodiments are well suited for scheduling microservices in pod-based computing environments.

For example, in an illustrative embodiment, a method comprises maintaining, in a set of nodes managed by a manager node, a scheduler in at least one node, wherein the scheduler is configured to self-manage execution of at least one workload by at least one execution unit instantiated on the node.

In some illustrative embodiments, maintaining the scheduler in the node may further comprise obtaining one or more schedule configuration parameters for the at least one workload, wherein the one or more schedule configuration parameters for the at least one workload are obtained during a registration of the at least one workload at the node.

In some illustrative embodiments, maintaining the scheduler in the node may further comprise initializing the at least one execution unit for the at least one workload at an execution unit initialization time determined from the one or more schedule configuration parameters.

In some illustrative embodiments, maintaining the scheduler in the node may further comprise calling the at least one execution unit to execute the at least one workload at the scheduled workload start time.

In some illustrative embodiments, maintaining the scheduler in the node may further comprise monitoring one or more executions of the at least one workload by the at least one execution unit and adjusting the execution unit initialization time relative to the scheduled workload start time in response to a result of the monitoring.

In some illustrative embodiments, the set of nodes managed by the manager node may be implemented via a pod-based management platform, wherein the node is a worker node of a set of worker nodes, the at least one execution unit is a pod instantiated on the worker node, and the at least one workload is a microservice in a container executed by the pod.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

Advantageously, illustrative embodiments provide one or more of: self-registering of microservices for a scheduled task; a node-level sidecar container to manage the scheduled task; a sustainable (e.g., resource power improved) microservice to control active pods for the scheduled microservice; and self-learning and/or self-adjusting of a time to initialize pods for each microservice.

These and other illustrative embodiments include, without limitation, apparatus, systems, methods and computer program products comprising processor-readable storage media.

### BRIEF DESCRIPTION OF THE DRAWINGS

FIG. 1 illustrates a pod-based container environment within which one or more illustrative embodiments can be implemented.

FIGS. 2A and 2B illustrate an exemplary central scheduler use case that can be implemented in the pod-based container environment of FIG. 1.

FIG. 3 illustrates a node-level sustainable pod scheduler according to an illustrative embodiment.

FIG. 4 illustrates a sidecar container associated with a microservice container implemented on the same pod.

FIG. 5 illustrates a sidecar container implementation of a node-level sustainable pod scheduler according to an illustrative embodiment.

FIG. 6 illustrates program code implemented by a node-level sustainable pod scheduler according to an illustrative embodiment.

FIG. 7 further illustrates a node-level sustainable pod scheduler according to an illustrative embodiment.

FIG. 8 illustrates a scheduling methodology according to an illustrative embodiment.

FIGS. 9 and 10 illustrate examples of processing platforms that may be utilized to implement at least a portion of an information processing system with node-level sustainable pod scheduler functionalities according to one or more illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed so as to encompass, for example, processing platforms comprising cloud and/or non-cloud computing and storage systems, as well as other types of processing systems comprising various combinations of physical and/or virtual processing resources. An information processing system may therefore comprise, by way of example only, at least one data center or other type of cloud-based system that includes one or more clouds hosting tenants that access cloud resources.

As the term is illustratively used herein, a container may be considered lightweight, stand-alone, executable software code that includes elements needed to run the software code. The container structure has many advantages including, but not limited to, isolating the software code from its surroundings, and helping reduce conflicts between different tenants or users running different software code on the same underlying infrastructure. The term “user” herein is intended to be broadly construed so as to encompass numerous arrangements of human, hardware, software or firmware entities, as well as combinations of such entities.

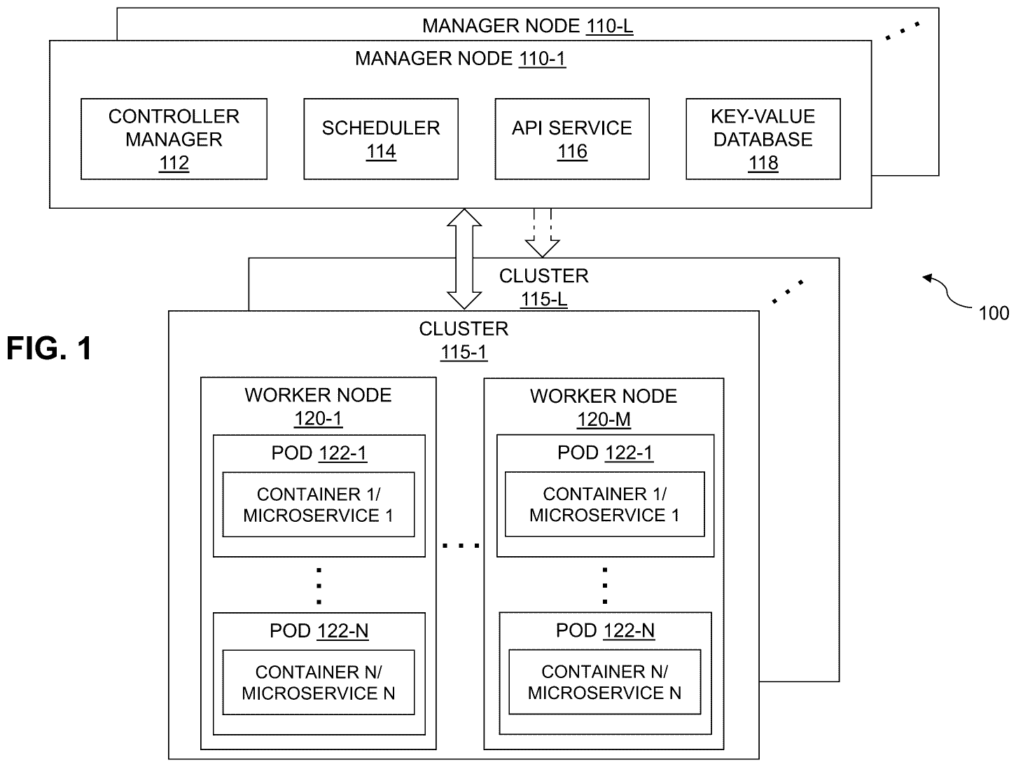

In illustrative embodiments, containers may be implemented using a Kubernetes container orchestration system. Kubernetes is an open-source system for automating application deployment, scaling, and management within a container-based information processing system comprised of components referred to as pods, nodes and clusters, as will be further explained below in the context of FIG. 1. Types of containers that may be implemented or otherwise adapted within the Kubernetes system include, but are not limited to, Docker containers or other types of Linux containers (LXCs) or Windows containers. Kubernetes has become the prevalent container orchestration system for managing containerized workloads. It is rapidly being adopted by many enterprise-based information technology (IT) organizations to deploy its application programs (applications). By way of example only, such applications may include stateless (or inherently redundant applications) and/or stateful applications. While the Kubernetes container orchestration system is used to illustrate various embodiments, it is to be understood that alternative container orchestration systems, as well as information processing systems other than container-based systems, can be utilized.

Some terminology associated with the Kubernetes container orchestration system will now be explained. In general, for a Kubernetes environment, one or more containers are part of a pod. Thus, the environment may be referred to, more generally, as a pod-based system, a pod-based container system, a pod-based container orchestration system, a pod-based container management system, a container-based orchestration system, or the like. As mentioned above, the containers can be any type of container, e.g., Docker container, etc. Furthermore, a pod is typically considered the smallest execution unit in the Kubernetes container orchestration environment. A pod encapsulates one or more containers. One or more pods are executed on a worker node. Multiple worker nodes form a cluster. A Kubernetes cluster is managed by at least one manager node. A Kubernetes environment may include multiple clusters respectively managed by multiple manager nodes. Furthermore, pods typically represent the respective processes running on a cluster. A pod may be configured as a single process wherein one or more containers execute one or more functions that operate together to implement the process. By way of example only, a pod may comprise a container configured to execute a microservice. Pods may each have a unique Internet Protocol (IP) address enabling pods to communicate with one another, and for other system components to communicate with each pod. Still further, pods may each have persistent storage volumes associated therewith. Configuration information (configuration objects) indicating how a container executes can be specified for each pod.

FIG. 1 depicts an example of a pod-based container orchestration environment 100. As shown, a plurality of manager nodes 110-1, . . . 110-L (herein each individually referred to as manager node 110 or collectively as manager nodes 110) are respectively operatively coupled to a plurality of clusters 115-1, . . . 115-L (herein each individually referred to as cluster 115 or collectively as clusters 115). As mentioned above, each cluster is managed by at least one manager node.

Each cluster 115 comprises a plurality of worker nodes 120-1, . . . 120-M (herein each individually referred to as worker node 120 or collectively as worker nodes 120). Each worker node 120 comprises a plurality of pods 122-1, . . . 122-N (herein each individually referred to as pod 122 or collectively as pods 122). However, it is to be understood that one or more worker nodes 120 can run a single pod 122 at a time. Each pod 122 comprises a set of containers 1, . . . N (different pods may have different numbers of containers) which respectively execute a set of microservices 1, . . . N. Each container can also execute more than one microservice. As used herein, a microservice may be referred to more generally as a containerized workload or simply a workload. Also, by way of example only, an application may comprise one or more microservices.

Also shown in FIG. 1, each manager node 110 comprises a controller manager 112, a scheduler 114, an application programming interface (API) service 116, and a key-value database 118, as will be further explained. However, in some embodiments, multiple manager nodes 110 may share one or more of the same controller manager 112, scheduler 114, API service 116, and key-value database 118.

Each manager node 110 manages the worker nodes 120, and therefore pods 122 and containers, in its corresponding cluster 115. More particularly, each manager node 110 controls operations in its corresponding cluster 115 utilizing the above-mentioned components, i.e., controller manager 112, scheduler 114, API service 116, and a key-value database 118.

By way of example, controller manager 112 executes control processes (controllers) that are used to manage operations in cluster 115.

By way of example, scheduler 114 typically schedules pods to run on particular nodes accounting for node resources and application execution requirements such as, but not limited to, deadlines. A non-limiting example of a scheduler 114 that is used in existing implementations is the above-mentioned Control-M or Cron Job scheduler. In some cases, the Control-M or Cron Job scheduler runs on manager node 110 as part of scheduler 114 and, in other cases, scheduler 114 can connect with a Control-M or Cron Job scheduler to centrally schedule pod execution.

By way of example, in a Kubernetes implementation, API service 116 exposes the Kubernetes API, which is the front end of the Kubernetes container orchestration system.

By way of example, key-value database 118 typically provides key-value storage for all cluster data including, but not limited to, configuration data objects generated, modified, deleted, and otherwise managed, during the course of system operations.

As mentioned above, with existing implementations, a dedicated scheduler such as a Control-M scheduler, a Cron Job scheduler, or the like is used for, or with, scheduler 114 to centrally manage the execution of pods 122 and thus the microservices running within the containers executing on pods 122. However, as further mentioned with respect to such an existing scheduler approach, microservices remain running at all times after service invocation, and when the scheduler 114 triggers them with appropriate attributes, the corresponding microservice promptly executes its designated task.

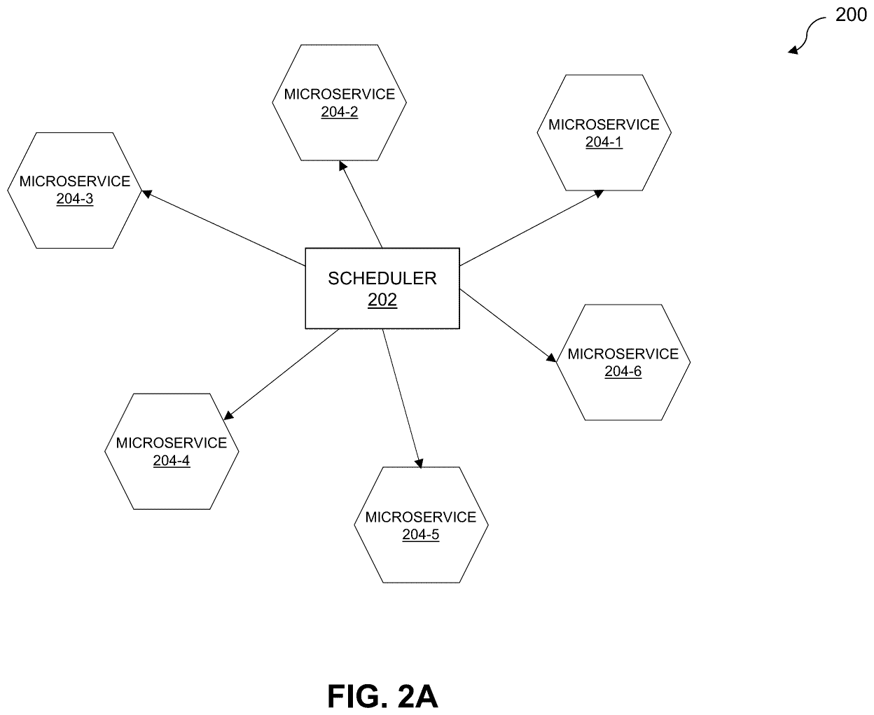

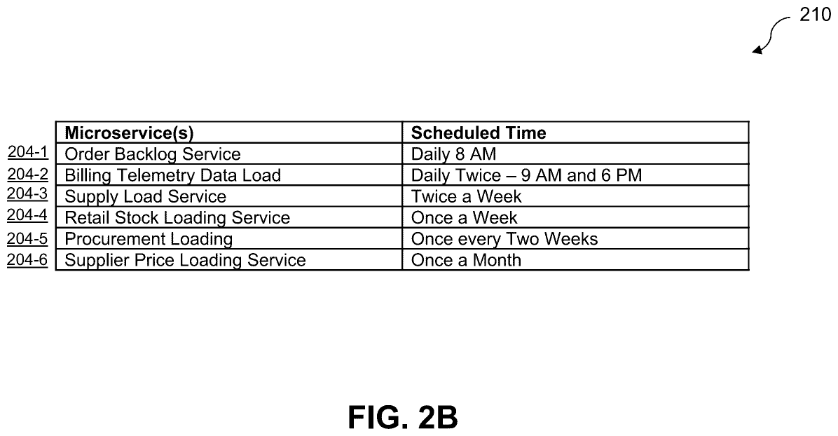

Such existing (external or internal) schedulers can schedule a job, for example, from hourly to daily to weekly to monthly or even to yearly. Assume a scheduler example as illustratively depicted in FIGS. 2A and 2B is implemented in a pod-based container orchestration system as depicted in FIG. 1. More particularly, in a centralized scheduler approach 200 in FIG. 2A, assume a scheduler 202 (e.g., part of or otherwise utilized by scheduler 114) implements a Control-M or Cron Job scheduler configured to schedule a plurality of microservices 204-1, 204-2, 204-3, 204-4, 204-5, and 204-6 (herein each individually referred to as microservice 204 or collectively as microservices 204). Assume also that microservices 204 are executed by containers running in pods 122. Further assume that each microservice 204 has the function and scheduled time as specified in a table 210 in FIG. 2B.

As shown, for example, microservice 204-1 is an order backlog service that runs daily starting at 8 AM, microservice 204-2 is a billing telemetry data load service that runs twice daily respectively starting at 9 AM and 6 PM, microservice 204-3 is a supply load service that runs twice a week, microservice 204-4 is a retail stock loading service that runs once a week, microservice 204-5 is a procurement loading service that runs once every two weeks, and microservice 204-6 is a supplier price loading service that runs once a month.

There are several technical issues with centralized scheduler approach 200 in FIG. 2A. First, pods 122, once initialized, run all the time and therefore consume resources (e.g., compute, store, and network resources of the underlying computing system on which worker nodes 120 reside), even if the microservices respectively associated therewith are not serving anything. For example, the pod running supplier price loading service (204-6) will be serving only once in a month with actual work. All other times, the pod will be running without serving anything. This consumes resources and power, and thus adds to carbon emission. Second, a centralized scheduler is a single point of failure for all services that are connected thereto, i.e., if scheduler 202 goes down (e.g., the scheduling software freezes or locks up or the underlying hardware crashes), none of microservices 204 will perform.

Illustrative embodiments address the above and other technical issues with respect to scheduling for container-based microservice platforms such as, but not limited to, a Kubernetes platform. For example, illustrative embodiments provide a decentralized pod scheduling approach that is implemented at a node level to enable each microservice running on a pod that runs on a node (e.g., worker node) to be locally aware (self-aware) of its schedule such that when needed to execute a microservice or workload, the corresponding pod enters a run mode, otherwise it is in a sleep mode. In some illustrative embodiments, in a sleep mode, the underlying computing system (e.g., compute, storage and network resources) maintains a low-power or no-power condition and data representing the state of the computing system is stored in memory (e.g., RAM). Thus, in the sleep mode, while the RAM remains active, the other resources of the computing system are not running and thus do not use any power or use minimal power. Then, in the run mode, the underlying computing system awakens and the resources are powered up to run the microservice or workload. Advantageously, by implementing a sleep mode/run mode paradigm, resources are saved and carbon emission is reduced. Further, in accordance with illustrative embodiments, microservice scheduling control is at the node level, i.e., implemented at a worker node 120, such that no centralized scheduler (as in existing approaches) can cause a single point of failure that brings down all microservices in the system. That is, a scheduler failure at the node level will only adversely affect the pods/containers/microservices running on the corresponding local node. Still further, a node level scheduler may be referred to herein as a “sustainable pod scheduler.” Sustainable here illustratively refers to the optimization of resource use (i.e., based on the sleep mode/run mode paradigm) in the underlying computing system upon which the worker node runs. In addition, a sustainable pod scheduler may be considered self-managing since, as will be further explained, the sustainable pod scheduler can monitor a set of pods and learn the length of time it takes to initialize the set of pods, and given the time that a microservice is scheduled to run, can adjust scheduling parameters to better manage (e.g., optimize) power and resources of the underlying computing system.

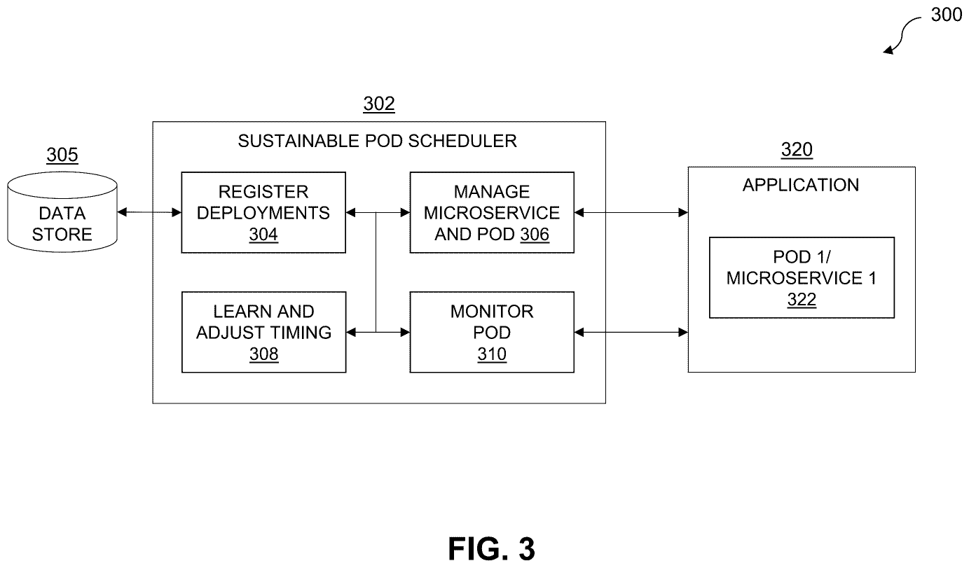

FIG. 3 depicts a sustainable pod scheduler environment 300 according to an illustrative embodiment. As shown, sustainable pod scheduler environment 300 comprises a sustainable pod scheduler 302 which, as will be described in further detail below, is configured to provide various functionalities (modules) to enable schedule management at a node level. For example, as further shown, sustainable pod scheduler 302 comprises functionalities to register deployments of microservices 304 in accordance with a data store 305, manage a given microservice and pod 306, or more than one microservice and pod, that reside on the corresponding node, learn and adjust timing 308, and monitor the given (one or more) microservice(s) and pod(s) 310. In the example of FIG. 3, sustainable pod scheduler 302 is managing an application 320 comprised of a pod/microservice 322 (pod 1/microservice 1).

As will be further explained below, one or more illustrative embodiments implement sustainable pod scheduler 302 on a given node as its own sidecar container separate from the one or more containers in which the one or more given microservices of the node are respectively implemented.

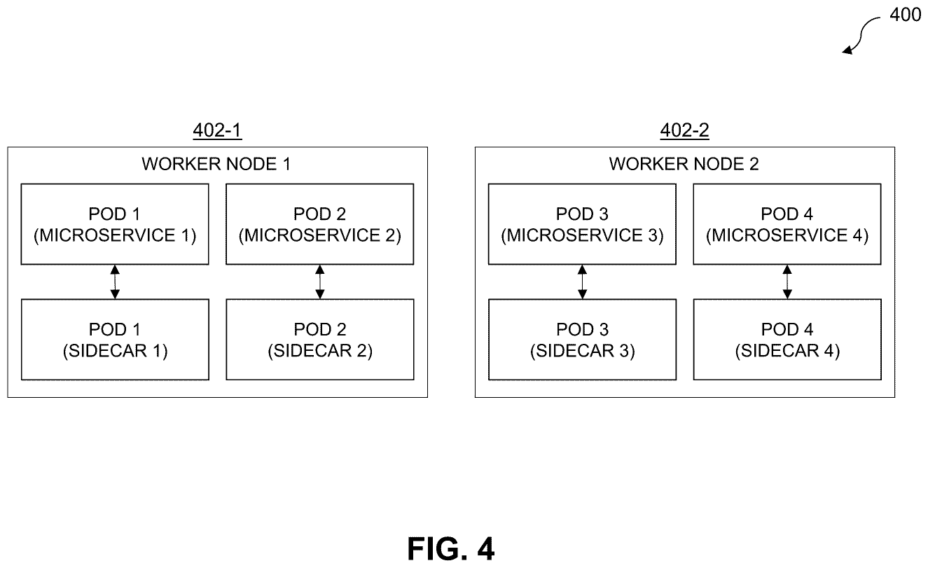

Typically, existing sidecar containers are implemented at a pod level whereby the sidecar container shares the same lifecycle, resources, and network namespace as its corresponding main container (application) within the same pod, but has its own file system and process space to execute tasks other than the tasks the corresponding main microservice executes. Such an existing implementation is illustrated in a cluster environment 400 of FIG. 4. Cluster environment 400 illustrates two worker nodes 402-1 and 402-3. Worker node 402-1 comprises two pods, i.e., pod 1 and pod 2, wherein each pod comprises a microservice and a sidecar, i.e., microservice 1 and sidecar 1 in pod 1 and microservice 2 and sidecar 2 in pod 2. Similarly, worker node 402-2 comprises two pods, i.e., pod 3 and pod 4, wherein each pod comprises a microservice and a sidecar, i.e., microservice 3 and sidecar 3 in pod 3 and microservice 4 and sidecar 4 in pod 4.

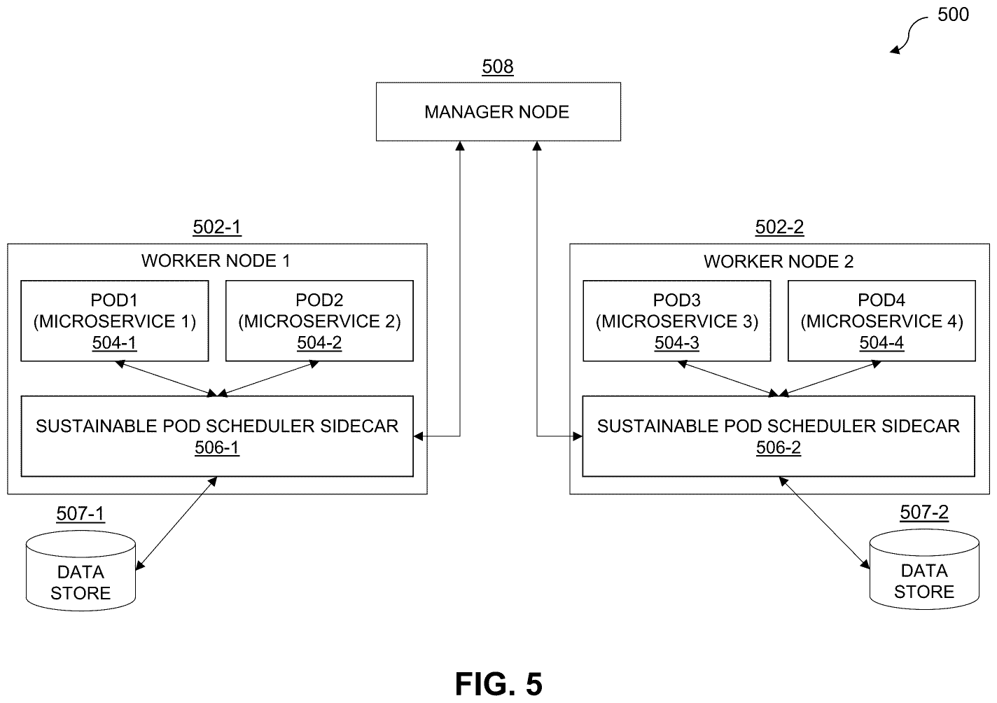

In contrast, sustainable pod scheduler 302 is implemented as a node-level sidecar container as shown in a cluster environment 500 of FIG. 5 according to one or more illustrative embodiments. As shown, cluster environment 500 illustrates two worker nodes 502-1 and 502-2. Worker node 502-1 comprises two pods 504-1 and 504-2, i.e., pod 1 and pod 2, respectively, wherein each pod comprises a microservice, i.e., microservice 1 in pod 1 and microservice 2 in pod 2. Further, worker node 502-1 comprises a sustainable pod scheduler sidecar 506-1 at the node level. Similarly, worker node 502-2 comprises two pods 504-3 and 504-4, i.e., pod 3 and pod 4, respectively, wherein each pod comprises a microservice, i.e., microservice 3 in pod 3 and microservice 4 in pod 4. Further, worker node 502-2 comprises a sustainable pod scheduler sidecar 506-2 at the node level.

Advantageously, each of sustainable pod scheduler sidecar 506-1 and sustainable pod scheduler sidecar 506-2 maintains the scheduled time of each microservice deployment on its corresponding node, microservice 1 on pod 504-1 and microservice 2 on pod 504-2 for worker node 502-1, and microservice 3 on pod 504-3 and microservice 4 on pod 504-4 for worker node 502-2. Each of sustainable pod scheduler sidecar 506-1 and sustainable pod scheduler sidecar 506-2 comprise their own data store, i.e., a data store 507-1 and a data store 507-2, respectively, and are operatively coupled to a manager node 508.

As will be further explained, each of sustainable pod scheduler sidecar 506-1 and sustainable pod scheduler sidecar 506-2 learns when to instantiate the required microservice in its corresponding worker node considering the time of initiation of each pod. For each of the microservices in a worker node, the number of pods to be initiated may be different and the resources inside a pod may be different. Thus, each microservice/pod initiation time may be different.

In some illustrative embodiments, each of sustainable pod scheduler sidecar 506-1 and sustainable pod scheduler sidecar 506-2 is deployed at the node level when the worker node is created in a namespace. In one non-limiting Kubernetes example, this can be implemented by modifying (e.g., update, enhance, or the like) a kubeadm script. Kubeadm is a tool configured to provide one or more scripts with a kubeadm init command and a kubeadm join command for creating Kubernetes clusters. For example, a kubeadm script initializes the worker node and joins the manager node. Thus, in accordance with one or more illustrative embodiments, it is realized herein that this is an advantageous place to enable deployment of a sidecar in the worker node level, i.e., deploy sustainable pod scheduler sidecar 506-1 in worker node 502-1 and deploy sustainable pod scheduler sidecar 506-2 in worker node 502-2. More particularly, the modified kubeadm script deploys the following in the worker node as a sidecar (shared for that worker node):
(i) Deploy sustainable pod scheduler sidecar 506-1 in worker node 502-1 and join to manager node 508; and
(ii) Initialize data store 507-1, e.g., filed-based, to hold the individual microservice registration(s) and their corresponding schedules in worker node 502-1.

Similarly, for worker node 502-2 (and any other worker node as may be needed/desired for high-availability computing), a modified kubeadm script deploys sustainable pod scheduler sidecar 506-1 and initializes data store 507-2.

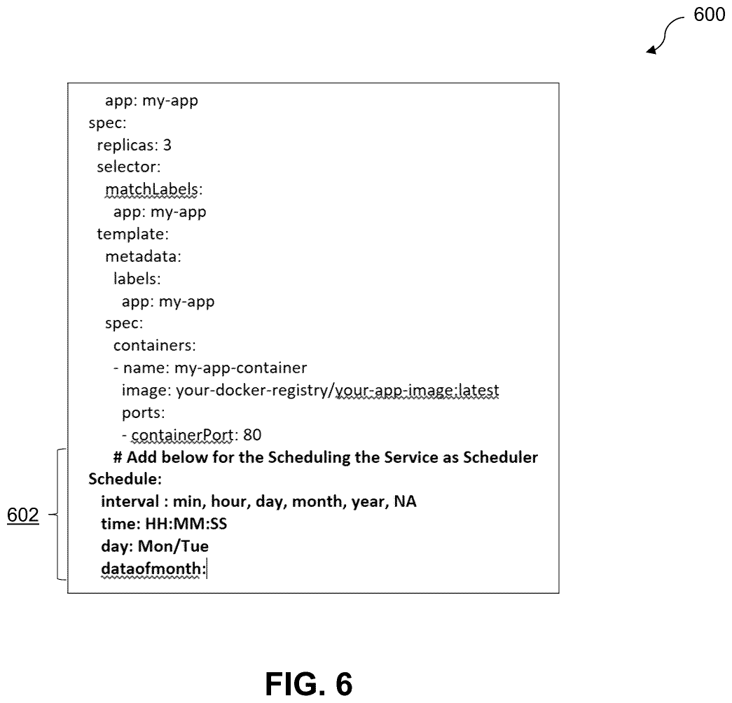

In some illustrative embodiments, each microservice deployment in the namespace has an additional custom code to register the microservice to the sustainable pod scheduler sidecar. FIG. 6 illustrates a deployment script 600 for a given microservice with program code 602 to register a microservice to a sustainable pod scheduler sidecar, e.g., in worker node 502-1, microservice 504-1 to sustainable pod scheduler sidecar 506-1. Similar program code 602 is used to respectively register microservice 504-2 to sustainable pod scheduler sidecar 506-1 in worker node 502-1, and microservices 504-3 and 504-4 to sustainable pod scheduler sidecar 506-2 in worker node 502-2. Advantageously, each schedule can be different, as needed/desired, for each microservice.

As per program code 602, one or more (e.g., in combination) of the following schedule configuration parameters can be set:
(i) “Interval” refers to the frequency or repeating time period at which a microservice is to be executed (e.g., daily, weekly, twice weekly, monthly, etc.).
(ii) “Time” refers to the time the service is to be executed (e.g., 9:00 AM, 6:00 PM, etc.);
(iii) “Day” refers to which day the service is to be executed (e.g., Monday, Tuesday, . . . etc.); and
(iv) “Date of month” refers to which date the service is to be executed (e.g., January 1^{st}, June 15^{th}, etc.).

A user (e.g., system administrator and/or other computing system) can choose any meaningful combination, e.g., schedule this microservice to be executed monthly on the first Monday of every month at 13:30:00 (1:30 PM). If not required, the value of a schedule configuration parameter can be set to NA (not applicable). In one or more illustrative embodiments, these schedule configuration parameters for each microservice are stored in a register deployment data store associated with each sustainable pod scheduler sidecar (e.g., data store 507-1 associated with sustainable pod scheduler sidecar 506-1, data store 507-2 associated with sustainable pod scheduler sidecar 506-2, etc.).

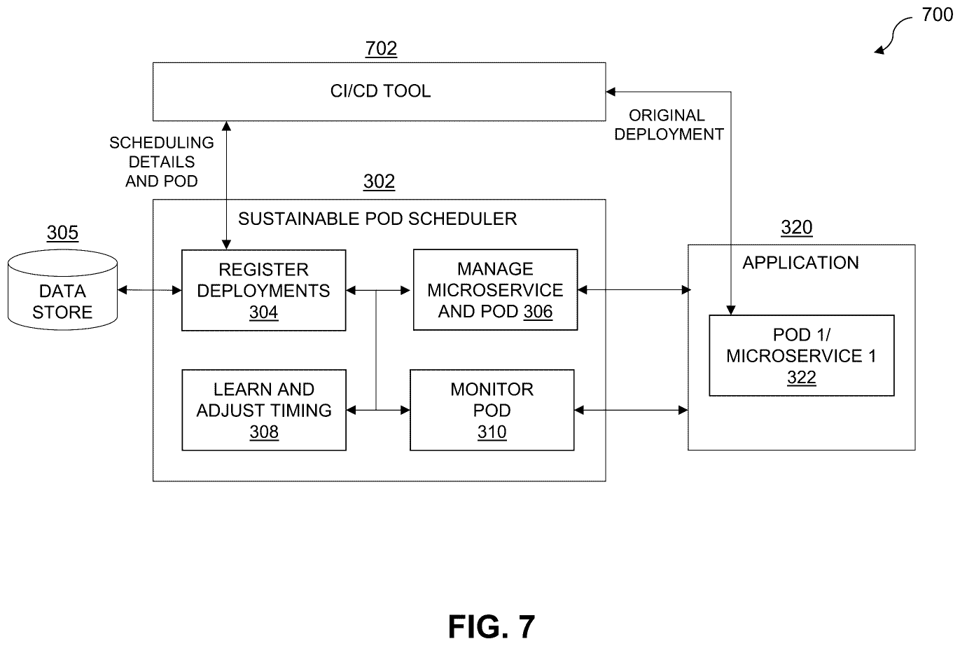

Referring now to FIG. 7, a sustainable pod scheduler environment 700 utilizing a continuous integration/continuous deployment (CI/CD) tool 702 to create sustainable pod scheduler environment 300 of FIG. 3 according to an illustrative embodiment is depicted. CI/CD is a software development practice in which, inter alia, incremental code changes can be made frequently and reliably. Recall that sustainable pod scheduler environment 300 comprises sustainable pod scheduler 302 (e.g., implemented as a node-level sidecar container as explained above). Further, recall that sustainable pod scheduler 302 comprises functionalities/modules to register deployments of microservices 304 in accordance with a data store 305, manage a given microservice and pod 306, or more than one microservice and pod, that reside on the corresponding node, learn and adjust timing 308, and monitor the given (one or more) microservice(s) and pod(s) 310. In the non-limiting example of FIG. 3, sustainable pod scheduler 302 is managing an application 320 comprised of a pod/microservice 322 (pod 1/microservice 1).

In some illustrative embodiments, functionalities/modules to manage the microservice and pod 306 comprise initializing the pod at a given time and calling the microservice at the scheduled time, e.g., wherein the schedule is configured and stored in data store 305 during performance of functionalities/modules to register deployment of microservices 304. By default, in some illustrative embodiments, pods are initialized at a preset time (e.g., 30 minutes) before the scheduled microservice run time since sustainable pod scheduler 302 may not initially be aware of how much time is needed to initialize a pod for a specific microservice (e.g., may not initially know what resources are configured in the pod and how many pod are going to be initialized).

In some illustrative embodiments, functionalities/modules to learn and adjust timing 308 comprise adjusting the length of the preset time (e.g., 30 minutes) at which the pod is initialized before the scheduled microservice run time. Since each microservice and pod initialization time varies, the functionalities/modules to monitor a given (one or more) microservice(s) and pod(s) 310 monitors and records the time it actually takes to initialize the pod such that it can be adjusted (by functionalities/modules to learn and adjust timing 308) from 30 minutes to less time or more time, e.g., with a buffer of 2 minutes (which can be configurable). Functionalities/modules to monitor a given (one or more) microservice(s) and pod(s) 310 can also stop execution of the pods (return to a sleep mode) once the scheduled task (microservice) is finished or stop one or more pods when necessary or otherwise desired.

For example, assume three microservices from table 210 in FIG. 2B are to execute in a specific node with the following number of pods needed: (i) order backlog job service—4 pods; (ii) supplier price load service—8 pods; and (iii) billing telemetry load service—32 pods.

In the first run, the pods will start to initialize 30 minutes earlier than the microservice run time. The time taken to initialize the pods is captured for each microservice. After 20 runs, as a non-limiting example, the maximum time to initialize the pods for each service is computed, a buffer (e.g., 1 minute) is added, and the schedule is updated in the corresponding data store for subsequent runs. By way of example only, the following scenario can occur:
(i) Order backlog job service—4 pods—average time: 6 seconds—new time to initialize: 1 minute, 6 seconds;
(ii) Supplier price load service—8 pods—average time: 3 minutes—new time to initialize: 4 minutes; and
(iii) Billing telemetry load service—32 pods—average time: 5 minutes—new time to initialize: 6 minutes.

If a subsequent run takes more time, sustainable pod scheduler 302 adjusts the scheduled time to initialize the pods. Note that, as explained above, the pods remain in a sleep mode (e.g., low or no power applied to the pod resources) until they are initialized and thus enter a run mode (e.g., power applied to the pod resources). Advantageously, as explained above, pods will not be running all the time, as in existing microservice/pod scheduling approaches, but rather will only be running when needed/desired.

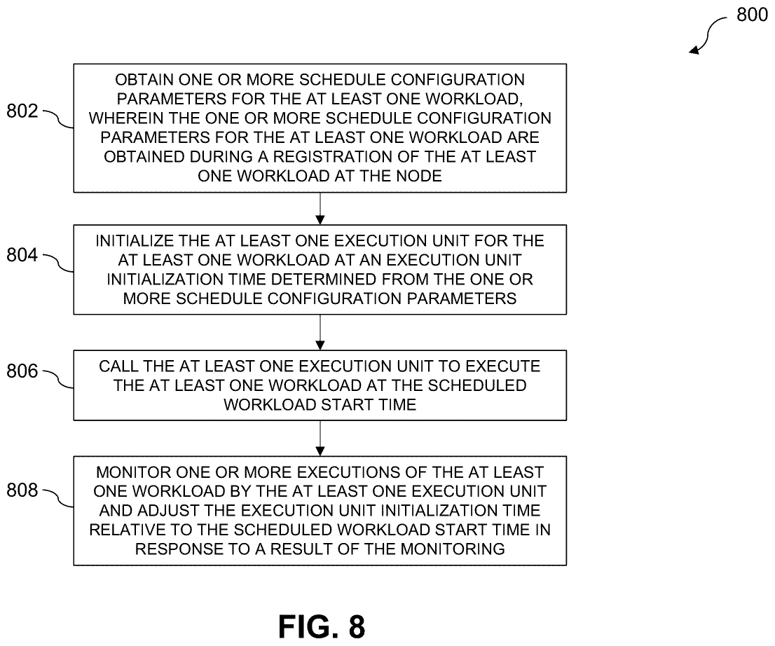

FIG. 8 illustrates a scheduling methodology 800 according to an illustrative embodiment. It is to be understood that, in illustrative embodiments, scheduling methodology 800 may be performed by, and/or caused to be performed by, each of sustainable pod scheduler 302 (FIGS. 3 and 7), sustainable pod scheduler sidecar 506-1 (FIG. 5), sustainable pod scheduler sidecar 506-2 (FIG. 5), and the like.

Scheduling methodology 800 maintains, in a set of nodes managed by a manager node, a scheduler in at least one node, wherein the scheduler is configured to self-manage execution of at least one workload by at least one execution unit instantiated on the node.

More particularly, step 802 obtains one or more schedule configuration parameters for the at least one workload, wherein the one or more schedule configuration parameters for the at least one workload are obtained during a registration of the at least one workload at the node.

Step 804 initializes the at least one execution unit for the at least one workload at an execution unit initialization time determined from the one or more schedule configuration parameters.

Step 806 calls the at least one execution unit to execute the at least one workload at the scheduled workload start time.

Step 808 monitors one or more executions of the at least one workload by the at least one execution unit and adjusts the execution unit initialization time relative to the scheduled workload start time in response to a result of the monitoring.

The particular processing operations and other system functionality described in conjunction with the diagrams described herein are presented by way of illustrative example only, and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

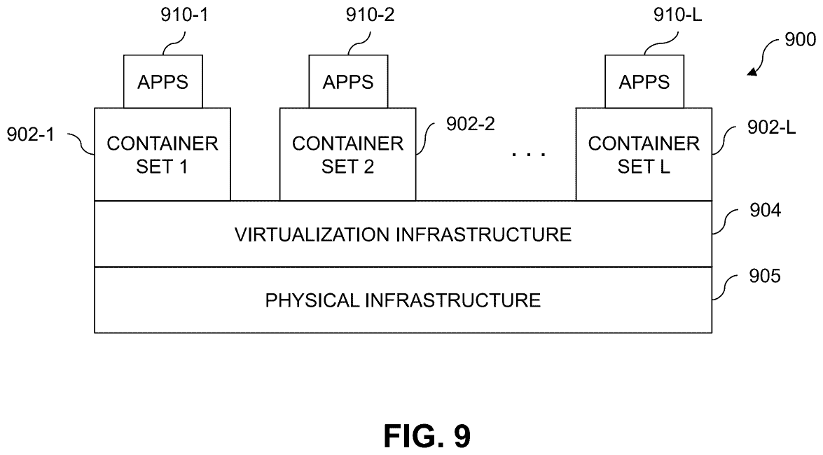

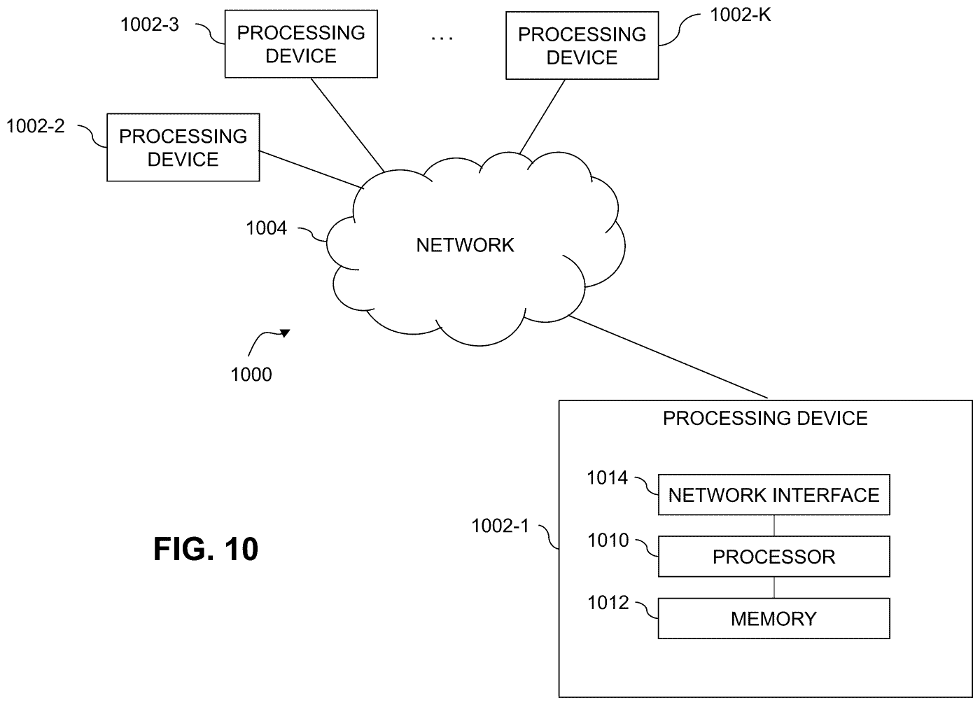

Illustrative embodiments of processing platforms utilized to implement functionality for ring architecture-based workload management in a microservice computing environment will now be described in greater detail with reference to FIGS. 9 and 10. Although described in the context of systems/module/processes of FIGS. 1-8, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of environments and processes depicted in FIGS. 1-8. The cloud infrastructure 900 comprises multiple container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure.

The cloud infrastructure 900 further comprises sets of applications 910-1, 910-2, . . . 910-L running on respective ones of the container sets 902-1, 902-2, . . . 902-L under the control of the virtualization infrastructure 904. The container sets 902 may comprise respective sets of one or more containers.

In some implementations of the FIG. 9 embodiment, the container sets 902 comprise respective containers implemented using virtualization infrastructure 904 that provides operating system level virtualization functionality, such as support for Kubernetes-managed containers.

As is apparent from the above, one or more of the processing modules or other components of environments and processes depicted in FIGS. 1-8 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 100 shown in FIG. 10.

The processing platform 1000 in this embodiment comprises at least a portion of environments and processes depicted in FIGS. 1-8 and includes a plurality of processing devices, denoted 1002-1, 1002-2, 1002-3, . . . 1002-K, which communicate with one another over a network 1004.

The network 1004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1002-1 in the processing platform 1000 comprises a processor 1010 coupled to a memory 1012.

The processor 1010 may comprise a microprocessor, a microcontroller, an application-specific integrated circuit (ASIC), a field-programmable gate array (FPGA) or other type of processing circuitry, as well as portions or combinations of such circuitry elements.

The memory 1012 may comprise random access memory (RAM), read-only memory (ROM), flash memory or other types of memory, in any combination. The memory 1012 and other memories disclosed herein should be viewed as illustrative examples of what are more generally referred to as “processor-readable storage media” storing executable program code of one or more software programs.

Articles of manufacture or computer program products comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and systems/modules/processes of FIGS. 1-8 may include additional or alternative processing platforms, as well as numerous distinct processing platforms in any combination, with each such platform comprising one or more computers, servers, storage devices or other processing devices.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality as disclosed herein are illustratively implemented in the form of software running on one or more processing devices.

In some illustrative embodiments, an apparatus comprises at least one processing platform comprising at least one processor coupled to at least one memory, the at least one processing platform, when executing program code, is configured to maintain, in a set of nodes managed by a manager node, a scheduler in at least one node, wherein the scheduler is configured to self-manage execution of at least one workload by at least one execution unit instantiated on the node.

In some illustrative embodiments, to maintain a scheduler in the node, the at least one processing platform is further configured to obtain one or more schedule configuration parameters for the at least one workload, wherein the one or more schedule configuration parameters for the at least one workload are obtained during a registration of the at least one workload at the node.

In some illustrative embodiments, the at least one processing platform is further configured to, at the node via the scheduler, initialize the at least one execution unit for the at least one workload at an execution unit initialization time determined from the one or more schedule configuration parameters.

In some illustrative embodiments, the execution unit initialization time is a time prior to a scheduled workload start time for the at least one workload specified by the one or more schedule configuration parameters.

In some illustrative embodiments, the at least one processing platform is further configured to, at the node via the scheduler, call the at least one execution unit to execute the at least one workload at the scheduled workload start time.

In some illustrative embodiments, the at least one processing platform is further configured to, at the given node via the scheduler, monitor one or more executions of the at least one workload by the at least one execution unit and adjust the execution unit initialization time relative to the scheduled workload start time in response to a result of the monitoring.

In some illustrative embodiments, the adjusting of the execution unit initialization time comprises moving the execution unit initialization time closer to or further from the scheduled workload start time in response to a result of the monitoring.

In some illustrative embodiments, the at least one processing platform is further configured to place the node in a first mode between the execution unit initialization time and a scheduled workload end time, and in a second mode otherwise.

In some illustrative embodiments, the first mode comprises resources utilized by the node being in a normal power-enabled condition (e.g., a run mode) and the second mode comprises resources utilized by the node being in one of a low power-enabled condition or a non-power-enabled condition (e.g., a sleep mode).

In some illustrative embodiments, the at least one processing platform comprises a pod-based management platform, wherein the node is a worker node of a set of worker nodes, the at least one execution unit is a pod instantiated on the worker node, and the at least one workload is a task in a container executed by the pod.

In some illustrative embodiments, the scheduler is implemented as a sidecar container separate from the pod.

In some illustrative embodiments, the sidecar container is configured to respectively self-manage execution of one or more other workloads on one or more other pods instantiated on the node.

In some illustrative embodiments, the at least one workload comprises a microservice.

In some illustrative embodiments, a method comprises maintaining, in a set of nodes managed by a manager node, a scheduler in at least one node, wherein the scheduler is configured to self-manage execution of at least one workload by at least one execution unit instantiated on the node.

In some illustrative embodiments, maintaining the scheduler in the node further comprises obtaining one or more schedule configuration parameters for the at least one workload, wherein the one or more schedule configuration parameters for the at least one workload are obtained during a registration of the at least one workload at the node.

In some illustrative embodiments, maintaining the scheduler in the node further comprises initializing the at least one execution unit for the at least one workload at an execution unit initialization time determined from the one or more schedule configuration parameters.

In some illustrative embodiments, maintaining the scheduler in the node further comprises calling the at least one execution unit to execute the at least one workload at the scheduled workload start time.

In some illustrative embodiments, maintaining the scheduler in the node further comprises monitoring one or more executions of the at least one workload by the at least one execution unit and adjusting the execution unit initialization time relative to the scheduled workload start time in response to a result of the monitoring.

In some illustrative embodiments, the set of nodes managed by the manager node are implemented via a pod-based management platform, wherein the node is a worker node of a set of worker nodes, the at least one execution unit is a pod instantiated on the worker node, and the at least one workload is a task in a container executed by the pod.

In some illustrative embodiments, a computer program product comprises a non-transitory processor-readable storage medium having stored therein program code of one or more software programs, wherein the program code when executed by at least one processing platform causes the at least one processing platform to maintain, in a set of nodes managed by a manager node, a scheduler in at least one node, wherein the scheduler is configured to self-manage execution of at least one workload by at least one execution unit instantiated on the node.

It should again be emphasized that the above-described embodiments are presented for purposes of illustration only. Many variations and other alternative embodiments may be used. For example, the disclosed techniques are applicable to a wide variety of other types of information processing systems, host devices, storage systems, container monitoring tools, container management or orchestration systems, container metrics, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing platform comprising at least one processor coupled to at least one memory, the at least one processing platform, when executing program code, is configured to:
maintain, in a set of nodes managed by a manager node, a scheduler in at least one node, wherein the scheduler is configured to self-manage execution of at least one workload by at least one execution unit instantiated on the node.

2. The apparatus of claim 1, wherein, to maintain a scheduler in the node, the at least one processing platform is further configured to obtain one or more schedule configuration parameters for the at least one workload, wherein the one or more schedule configuration parameters for the at least one workload are obtained during a registration of the at least one workload at the node.

3. The apparatus of claim 2, wherein the at least one processing platform is further configured to, at the node via the scheduler, initialize the at least one execution unit for the at least one workload at an execution unit initialization time determined from the one or more schedule configuration parameters.

4. The apparatus of claim 3, wherein the execution unit initialization time is a time prior to a scheduled workload start time for the at least one workload specified by the one or more schedule configuration parameters.

5. The apparatus of claim 4, wherein the at least one processing platform is further configured to, at the node via the scheduler, call the at least one execution unit to execute the at least one workload at the scheduled workload start time.

6. The apparatus of claim 5, wherein the at least one processing platform is further configured to, at the node via the scheduler, monitor one or more executions of the at least one workload by the at least one execution unit and adjust the execution unit initialization time relative to the scheduled workload start time in response to a result of the monitoring.

7. The apparatus of claim 6, wherein the adjusting of the execution unit initialization time comprises moving the execution unit initialization time closer to or further from the scheduled workload start time in response to a result of the monitoring.

8. The apparatus of claim 4, wherein the at least one processing platform is further configured to place the node in a first mode between the execution unit initialization time and a scheduled workload end time, and in a second mode otherwise.

9. The apparatus of claim 8, wherein the first mode comprises resources utilized by the node being in a normal power-enabled condition and the second mode comprises resources utilized by the node being in one of a low power-enabled condition or a non-power-enabled condition.

10. The apparatus of claim 1, wherein the at least one processing platform comprises a pod-based management platform, wherein the node is a worker node of a set of worker nodes, the at least one execution unit is a pod instantiated on the worker node, and the at least one workload is a task in a container executed by the pod.

11. The apparatus of claim 10, wherein the scheduler is implemented as a sidecar container separate from the pod.

12. The apparatus of claim 11, wherein the sidecar container is configured to respectively self-manage execution of one or more other workloads on one or more other pods instantiated on the node.

13. The apparatus of claim 1, wherein the at least one workload comprises a microservice.

14. A method comprising:
maintaining, in a set of nodes managed by a manager node, a scheduler in at least one node, wherein the scheduler is configured to self-manage execution of at least one workload by at least one execution unit instantiated on the node.

15. The method of claim 14, wherein maintaining the scheduler in the node further comprises obtaining one or more schedule configuration parameters for the at least one workload, wherein the one or more schedule configuration parameters for the at least one workload are obtained during a registration of the at least one workload at the node.

16. The method of claim 15, wherein maintaining the scheduler in the node further comprises initializing the at least one execution unit for the at least one workload at an execution unit initialization time determined from the one or more schedule configuration parameters.

17. The method of claim 16, wherein maintaining the scheduler in the node further comprises calling the at least one execution unit to execute the at least one workload at a scheduled workload start time.

18. The method of claim 17, wherein maintaining the scheduler in the node further comprises monitoring one or more executions of the at least one workload by the at least one execution unit and adjusting the execution unit initialization time relative to the scheduled workload start time in response to a result of the monitoring.

19. The method of claim 14, wherein the set of nodes managed by the manager node are implemented via a pod-based management platform, wherein the node is a worker node of a set of worker nodes, the at least one execution unit is a pod instantiated on the worker node, and the at least one workload is a task in a container executed by the pod.

20. A computer program product comprising a non-transitory processor-readable storage medium having stored therein program code of one or more software programs, wherein the program code when executed by at least one processing platform causes the at least one processing platform to maintain, in a set of nodes managed by a manager node, a scheduler in at least one node, wherein the scheduler is configured to self-manage execution of at least one workload by at least one execution unit instantiated on the node.
